(19) United States
(12) Patent Application Publication
(10) Pub. No.: US 2016/0168364 A1
(43) Pub. Date: Jun. 16, 2016

(54) RUBBER COMPOSITION FOR TIRE AND PNEUMATIC TIRE

(71) Applicant: Toyo Tire & Rubber Co., Ltd., Osaka (JP)

(72) Inventor: Fumihiko Nakamura, Osaka-shi (JP)

(73) Assignee: Toyo Tire & Rubber Co., Ltd., Osaka (JP)

(21) Appl. No.: 14/962,657

(22) Filed: Dec. 8, 2015

(30) Foreign Application Priority Data
Dec. 16, 2014 (JP) 2014-254227

(51) Int. Cl. C08L 9/00; C08L 7/00

(52) U.S. Cl. CPC C08L 9/00; C08L 7/00; C08L 2205/03

(57) ABSTRACT

The increase of rubber hardness by the lapse of time is suppressed, and excellent on-ice performance due to porous cellulose particles is suppressed from being decreased. A rubber composition for a tire including 100 parts by mass of a rubber component including a diene rubber, from 0.3 to 20 parts by mass of porous cellulose particles having a porosity of from 75 to 95%, and from 1 to 30 parts by mass of a polymer gel that is crosslinked diene polymer particles having a functional group containing a hetero atom is disclosed. Furthermore, a pneumatic tire having a tread including the rubber composition is disclosed.

### CROSS-REFERENCE TO RELATED APPLICATIONS

This application is based upon and claims the benefit of priority from the prior Japanese Patent Application No. 2014-254227, filed on Dec. 16, 2014; the entire contents of which are incorporated herein by reference.

### BACKGROUND

1. Technical Field

The present invention relates to a rubber composition suitable for use in a tire, and a pneumatic tire using the rubber composition.

2. Related Art

There is a tire such as a studless tire in which running performance on an ice-covered road surface (that is, on-ice performance) is required. In such a tire, in order to improve a grounding property thereof to an ice-covered road surface by letting a tread have flexibility at low temperature, rubber hardness is set to low hardness by using a diene rubber having low glass transition temperature in a rubber composition used for a tread. Furthermore, in order to increase friction force on ice, it is known to add vegetable granules obtained by pulverizing seed shells or fruit cores, or add a bamboo charcoal powder which removes a water layer on ice.

As the technology to improve on-ice performance, JP-A-2011-012110 discloses to add porous cellulose particles having a porosity of from 75 to 95% to a tread rubber. Thus, on-ice performance can be improved while suppressing the decrease of abrasion resistance by adding porous cellulose particles to a tread rubber. However, when rubber has become hard by change over the years, on-ice performance is deteriorated. Effective measures for suppressing hardness change of a rubber due to the lapse of time have not conventionally been known in a system containing porous cellulose particles.

JP-A-2008-024792 discloses that a polymer gel which is crosslinked diene polymer particles having low glass transition point is added to a rubber composition for a tread of a winter tire. However, in this patent document, the polymer gel is added to improve on-ice performance by the improvement of adhesive friction force, and it is not disclosed that hardness change of a rubber due to the lapse of time can be suppressed by adding the polymer gel to a system containing porous cellulose particles.

JP-A-2010-248282 discloses that the weight of a tire is intended to decrease while maintaining reinforcement and low heat generation property by using a polymer gel having high glass transition point together with a lignin derivative, and further discloses that the lignin derivative may encompass a saccharide such as cellulose. Furthermore, WO2008/132061A2 (US2010/197829A1) discloses a rubber composition containing a polymer gel having a hydroxyl group, and further discloses that cellulose may be used as an optional filler. However, the cellulose described in those patent documents is not porous cellulose particles that contribute to the improvement of on-ice performance, and those patent documents do not suggest the combined use of porous cellulose particles and polymer gel.

As described above, not only the improvement of initial on-ice performance but the suppression of change over the years of on-ice performance are required, but the conventional technology does not sufficiently respond to those requirements, and further improvement is required.

### SUMMARY

In view of the above, an object of the embodiment is to provide a rubber composition for a tire that can suppress the increase of rubber hardness by the lapse of time and can suppress the decrease of excellent on-ice performance by porous cellulose particles.

The rubber composition for a tire according to the embodiment includes 100 parts by mass of a rubber component including diene rubber, from 0.3 to 20 parts by mass of porous cellulose particles having a porosity of from 75 to 95%, and from 1 to 30 parts by mass of a polymer gel that is crosslinked diene polymer particles having a functional group containing a hetero atom.

The pneumatic tire according to the embodiment includes a tread including the rubber composition.

According to the embodiment, in a rubber composition system containing porous cellulose particles, when the polymer gel is further added thereto, the increase of rubber hardness by the lapse of time can be suppressed, and excellent on-ice performance due to the porous cellulose particles can be suppressed from being decreased by the lapse of time.

### DETAILED DESCRIPTION

The rubber composition according to the embodiment includes a rubber component including diene rubber, having added thereto porous cellulose particles and a polymer gel having a functional group.

Examples of the diene rubber used as a rubber component include various diene rubbers generally used in a rubber composition for a tire tread, such as natural rubber (NR), polyisoprene rubber (IR), polybutadiene rubber (BR), styrene-butadiene rubber (SBR), styrene-isoprene copolymer rubber, butadiene-isoprene copolymer rubber or styrene-isoprene-butadiene copolymer rubber. Those diene rubbers can be used in any one kind alone or as blends of two or more kinds. The polymer gel is not included in the rubber component.

As the rubber component, a blend of natural rubber and other diene rubber is preferably used, and a blend of natural rubber (NR) and polybutadiene rubber (BR) is particularly preferably used. Although not particularly limited, considering a balance between low temperature characteristics of the rubber composition and processability and tear resistance, a ratio between natural rubber and other diene rubber is that NR/BR ratio is preferably from 30/70 to 80/20, and may be 40/60 to 70/30, in mass ratio.

The porous cellulose particles are cellulose particles having a porous structure in which a porosity is from 75 to 95%, and when the porous cellulose particles are added to the rubber composition, on-ice performance can be remarkably improved. When the porosity of the porous cellulose particles is 75% or more, the effect of improving on-ice performance is excellent. On the other hand, when the porosity is 95% or less, strength of the particles can be increased. The porosity is preferably from 80 to 90%.

The porosity of the porous cellulose particles can be obtained from the following formula by measuring a volume of a certain mass of a sample (that is, the porous cellulose particles) with a measuring cylinder and obtaining a bulk specific gravity.

Porosity (%)={1−(bulk specific gravity [g/ml] of sample)/(true specific gravity [g/ml] of sample)}×100

True specific gravity of cellulose is 1.5.

The particle diameter of the porous cellulose particles is not particularly limited, but from the standpoint of abrasion resistance, the porous cellulose particles having the average particle diameter of 1,000 μm or less are preferably used. The lower limit of the average particle diameter is not particularly limited, but is preferably 5 μm or more. The average particle diameter is more preferably from 100 to 800 μm, and still more preferably from 200 to 800 μm.

Spherical particles having a ratio of long diameter/short diameter of from 1 to 2 are preferably used as the porous cellulose particles. When the particles having such a spherical structure are used, dispersibility of the particles into the rubber composition is improved, and this can contribute to improve on-ice performance and to maintain abrasion resistance. The ratio of long diameter/short diameter is more preferably from 1.0 to 1.5.

The average particle diameter of the porous cellulose particles and the ratio of long diameter/short diameter thereof are obtained as follows. The porous cellulose particles are observed with a microscope to obtain an image. Using the image, the long diameter and short diameter (in the case where the long diameter and short diameter are the same, a length in a certain axis direction and a length in an axis direction perpendicular to the certain axis direction) are measured in 100 particles, and its average value is calculated. Thus, the average particle diameter is obtained. Furthermore, the ratio of long diameter/short diameter is obtained from the average value of values obtained by dividing the long diameter by the short diameter.

The porous cellulose particles are commercially available as “VISCOPEARL” manufactured by Rengo Co., Ltd., and further are described in JP-A-2001-323095 and JP-A-2004-115284 (the entire contents of those references being incorporated herein by reference), and those porous cellulose particles can be preferably used.

The amount of the porous cellulose particles added is preferably from 0.3 to 20 parts by mass per 100 parts by mass of the rubber component. When the amount of the porous cellulose particles added is 0.3 parts by mass or more, the effect of improving on-ice performance can be enhanced. On the other hand, when the amount is 20 parts by mass or less, rubber hardness can be suppressed from becoming too high, and deterioration of abrasion resistance can be suppressed. The amount of the porous cellulose particles added is more preferably from 1 to 15 parts by mass, and still more preferably from 3 to 15 parts by mass, per 100 parts by mass of the rubber component.

The polymer gel is crosslinked diene polymer particles, and in the embodiment, the polymer gel having a functional group containing a hetero atom is used. When the polymer gel is added to the rubber composition having the porous cellulose particles added thereto, the increase of rubber hardness by the lapse of time can be suppressed, and as a result, the decrease of on-ice performance by the lapse of time can be suppressed.

The polymer gel is a gelled rubber that can be produced by crosslinking a rubber dispersion, and can be called a rubber gel. Examples of the rubber dispersion include a rubber latex produced by emulsion polymerization, and a rubber dispersion obtained by emulsifying solution-polymerized rubber in water. Examples of the crosslinking agent include organic peroxide, an organic azo compound and a sulfur type crosslinking agent. The crosslinking of the diene polymer particles can be conducted by copolymerization with a polyfunctional compound having a crosslinking function during emulsion polymerization. Specifically, the methods disclosed in, for example, JP-A-10-204225 (U.S. Pat. No. 6,184,296B1), JP-T-2004-504465 (WO2002/08328, US2002/077414A1) (the term “JP-T” as used herein means a published Japanese translation of a PCT patent application), JP-T-2004-506058 (WO2002/12389, US2002/0049282A1), and JP-T-2004-530760 (WO2002/102890, US2003/092827A1) (the entire contents of those references being incorporated herein by reference) can be used.

Examples of the diene polymer constituting the polymer gel include natural rubber, polyisoprene rubber, styrene-butadiene rubber, polybutadiene rubber, styrene-isoprene rubber, butadiene-isoprene rubber and styrene-isoprene-butadiene copolymer rubber. Those may be used in one kind alone or as mixtures of two more kinds thereof The diene polymer preferably includes polybutadiene rubber and/or styrene-butadiene rubber as a main component.

The glass transition temperature (Tg) of the polymer gel is preferably 0° C. or lower, and the decrease of on-ice performance can be suppressed by the temperature range. The glass transition temperature is preferably from −90 to 0° C., and more preferably from −10 to −80° C. The glass transition temperature is a value measured using differential scanning calorimetry (DSC) according to JIS K7121 (temperature rising rate: 20° C./min).

The average particle diameter of the polymer gel is not particularly limited, and, for example, DVN value (d₅₀) by DIN 53 206 may be from 5 to 2,000 nm, preferably from 10 to 500 nm, and more preferably from 20 to 200 nm.

The polymer gel used in the embodiment has a functional group containing a hetero atom. The polymer gel can interact (that is, have reactivity or affinity) with a functional group such as a hydroxyl group of the porous cellulose particles. Therefore, it is assumed that the polymer gel contributes to the improvement of performance. Examples of the functional group of the polymer gel include groups having a hetero atom such as oxygen atom or nitrogen atom, and the preferred examples of the functional group include at least one selected from the group consisting of a hydroxyl group, an amino group, a carboxyl group, an alkoxyl group and an epoxy group. The amino group is not only primary amino group, but may be a secondary or tertiary amino group. In the case of the secondary or tertiary amino group, the total carbon atom number of a hydrocarbon group as a substituent group is preferably 15 or less. Examples of the alkoxyl group include methoxy group, ethoxy group, propoxy group and butoxy group that are represented by —OR (wherein R represents, for example, an alkyl group having from 1 to 4 carbon atoms). The alkoxyl group may be contained as an alkoxysilyl group such as trialkoxysilyl group, alkyldialkoxysilyl group or dialkylalkoxysilyl group. Examples of the carboxyl group include maleic acid, phthalic acid, acrylic acid and methacrylic acid. The carboxyl group may be an acid anhydride group including an anhydride of dicarboxylic acid such as maleic acid or phthalic acid. Of those, a hydroxyl group is preferably used as the functional group of the polymer gel.

The polymer gel having the functional group may be synthesized using a monomer having the functional group introduced therein as the monomer at the time of polymerization of the diene polymer, and a terminal-modified polymer can be used, which has the functional group introduced into an active terminal after polymerization of the diene polymer. Furthermore, the functional group may be introduced into a polymer terminal by using a compound generating the functional group as an initiator at the time of polymerization. Furthermore, after preparing the diene polymer particles by the crosslinking, the functional group can also be incorporated in the particle surface by reacting a compound having the functional group with C═C double bond on the particle surface.

The amount of the polymer gel added is preferably from 1 to 30 parts by mass per 100 parts by mass of the rubber component. When the amount of the polymer gel added is 1 part by mass or more, the effect of suppressing change by the lapse of time of rubber hardness can be enhanced. On the other hand, when the amount is 30 parts by mass or less, the decrease of abrasion resistance can be suppressed. The amount of the polymer gel added is more preferably from 3 to 20 parts by mass per 100 parts by mass of the rubber component.

The rubber composition according to the embodiment may further contain vegetable granules and/or a pulverized product of a porous carbonized material of a plant, in addition to the porous cellulose particles and the polymer gel. When the vegetable granules and the pulverized product of a porous carbonized material are further used, on-ice performance can be further improved.

Examples of the vegetable granules include pulverized products of seed shells, fruit cores (that is, fruit stones), grains and grain cores, and the like, and least one of those can be added. Specific examples of vegetable granules include pulverized products of fruit cores and seed shells, such as walnut, apricot, camellia, peach, plum (Japanese apricot), ginkgo nut, peanut, chestnut and the like; pulverized products of grains such as rice, wheat, foxtail millet, barnyard millet, corn and the like; and pulverized products of grain cores, such as corncob. Those are harder than ice, and therefore can develop the scratch effect to an ice-covered road surface. Vegetable granules surface-treated with a rubber adhesiveness improving agent in order to improve an affinity for a rubber and prevent dropout may be used as the vegetable granules. Examples of the rubber adhesiveness improving agent include materials (RFL liquid) including a mixture of a resorcin-formalin resin initial condensate and a latex, as a main component.

The average particle diameter of the vegetable granules is not particularly limited. However, in order to develop the scratch effect and prevent dropout from a tread, 90% volume particle diameter (D90) is preferably from 100 to 600 μm, more preferably from 150 to 500 μm, and still more preferably from 200 to 400 μm. The D90 means a particle diameter at an integrated value of 90% in a particle size distribution (volume standard) measured by a laser diffraction scattering method.

The pulverized product of the porous carbonized material is a product obtained by pulverizing a porous material comprising a solid product including carbon as a main component obtained by carbonizing a plant such as tree or bamboo as a raw material, and can increase water absorption and water removal effect of a water layer generated on an ice-covered road surface. A pulverized product of bamboo charcoal (bamboo charcoal-pulverized product) may be used as one example of the pulverized product of the porous carbonized material. The bamboo charcoal-pulverized product can be obtained by pulverizing bamboo charcoal obtained by smothering and carbonizing a bamboo material using a kiln, into a powder using the conventional pulverizing machine. The particle diameter of the pulverized product of the porous carbonized material is not particularly limited, but it is preferred that 90% volume particle diameter (D90) is from 10 to 500 μm.

In the case where the vegetable granules and the pulverized product of the porous carbonized material are added, the addition amount thereof is preferably from 0.5 to 20 parts by mass, and more preferably from 1 to 10 parts by mass, in the total amount of those, per 100 parts by mass of the rubber component. As one embodiment, in the case where the vegetable granules are added, the addition amount thereof is preferably from 0.5 to 20 parts by mass, and more preferably from 1 to 10 parts by mass, per 100 parts by mass of the rubber component.

The rubber composition according to the embodiment can appropriately contain compounding chemicals generally used in rubber industries, such as a reinforcing filler such as carbon black or silica, a process oil, zinc flower, stearic acid, a softener, a plasticizer, an age resister (amine-ketone type, aromatic secondary amine type, phenol type, imidazole type or the like), a vulcanizing agent and a vulcanization accelerator (guanidine type, thiazole type, sulfenamide type, thiuram type or the like) in ordinary ranges, in addition to each of the above-described components.

The carbon black is not particularly limited, and the conventional various kinds of carbon black can be used. For example, in the case where the rubber composition is used in a tread part of a winter tire such as a studless tire, carbon black having a nitrogen adsorption specific surface area (N₂SA) (JIS K6217-2) of from 70 to 150 m²/g and DBP oil absorption amount (JIS K6217-4) of from 100 to 150 ml/100 g is preferably used from the standpoints of low temperature performance, abrasion resistance performance and reinforcement of a rubber. Specific examples of the carbon black include carbon blacks of SAF grade, ISAF grade and HAF grade. The amount of the carbon black added is preferably from 10 to 80 parts by mass, and more preferably from 15 to 50 parts by mass, per 100 parts by mass of the rubber component.

Silica is not particularly limited. For example, wet silica such as wet precipitated silica or wet gelled silica is preferably used. BET specific surface area (measured according to BET method described in JIS K6430) of silica is not particularly limited. The BET specific surface area is preferably from 90 to 250 m²/g, and more preferably from 150 to 220 m²/g. The amount of the silica added is preferably from 10 to 50 parts by mass, and more preferably from 15 to 50 parts by mass, per 100 parts by mass of the rubber component from the standpoints of a balance of tan δ and reinforcement of a rubber.

In the case where the silica is added to the rubber composition, it is preferred to concurrently use a silane coupling agent such as sulfide silane or mercaptosilane. The amount of the silane coupling agent used is preferably from 2 to 20 mass % based on the amount of the silica added.

The amount of the reinforcing filler including carbon black and/or silica is not particularly limited, and, for example, may be from 10 to 150 parts by mass, preferably from 20 to 100 parts by mass, and more preferably from 30 to 80 parts by mass, per 100 parts by mass of the rubber component.

Examples of the vulcanizing agent include sulfur components such as powdered sulfur, precipitated sulfur, colloidal sulfur, insoluble sulfur and highly dispersive sulfur. Although not particularly limited, the amount of the vulcanizing agent added is preferably from 0.1 to 10 parts by mass, more preferably from 0.5 to 5 parts by mass, and still more preferably from 1 to 3 parts by mass, per 100 parts by mass of the rubber component. The amount of the vulcanization accelerator added is preferably from 0.1 to 7 parts by mass, and more preferably from 0.5 to 5 parts by mass, per 100 parts by mass of the rubber component.

The rubber composition according to the embodiment can be prepared by kneading the necessary components according to the conventional method using a mixing machine generally used, such as Banbury mixer, a kneader or rolls. Specifically, porous cellulose, a polymer gel and other additives excluding a vulcanizing agent and a vulcanization accelerator are added to diene rubber, followed by kneading, in a first mixing step (non-processing kneading step). A vulcanizing agent and a vulcanization accelerator are added to the mixture thus obtained, followed by kneading, in a final mixing step (processing kneading step). Thus, a rubber composition can be prepared.

The rubber composition according to the embodiment can be used in, for example, tires for various uses, such as for passenger cars or for heavy load of trucks or buses. The rubber composition is preferably used as a rubber composition for a tread part of a pneumatic tire, or for a tread part of winter tires such as studless tires or snow tires.

The pneumatic tire according to one embodiment can be produced by preparing a tread part of a tire by an extruder for rubber using the rubber composition, forming an unvulcanized tire, and then vulcanization molding the unvulcanized tire at a temperature of, for example, from 140 to 180° C. In the case where a rubber composition is applied to a pneumatic tire having a cap/base structure in a tread rubber, the rubber composition of the embodiment may be applied to only a cap tread at a side of a ground-contact surface of a tire.

### EXAMPLES

Examples of the invention are described below, but the invention is not construed as being limited to those examples.

Banbury mixer was used. Components other than sulfur and a vulcanization accelerator were added and mixed according to the formulations (parts by mass) shown in Table 1 below in a first mixing step (discharge temperature: 160° C.). Sulfur and a vulcanization accelerator were added to and mixed with the mixture obtained above in a final mixing step (discharge temperature: 90° C.). Thus, a rubber composition for a tire tread was prepared. The details of each component in Table 1 are as follow.

NR: RS S#3

BR: “BR01” manufactured by JSR Corporation

Carbon black: “SEAST KH (N339)” manufactured by Tokai Carbon Co., Ltd. (N₂SA: 93 m²/g, DBP: 119 ml/100 g)

Silica: “NIPSIL AQ” manufactured by Tosoh Silica Corporation (BET: 205 m²/g)

Silane coupling agent: “Si75” manufactured by Degussa

Paraffin oil: “JOMO PROCESS P200” manufactured by JX Nippon Oil & Sun-Energy Corporation

Stearic acid: “LUNAC S-20” manufactured by Kao Corporation

Zinc flower: “Zinc Flower #1” manufactured by Mitsui Mining & Smelting Co., Ltd.

Age resister: “ANTIGEN 6C” manufactured by Sumitomo Chemical Co., Ltd.

Wax: “OZOACE 0355” manufactured by Nippon Seiro Co., Ltd.

Vulcanization accelerator: “SOXINOL CZ” manufactured by Sumitomo Chemical Co., Ltd.

Sulfur: “POWDERED SULFUR” manufactured by Tsurumi Chemical Industry Co., Ltd.

Vegetable granules: Granules obtained by subjecting pulverized walnut shells (“SOFT GRIT #46” manufactured by Nippon Walnut Co., Ltd.) to surface treatment with RFL treating liquid according to the method described in paragraph 0015 of JP-A-10-7841 (D90 of vegetable granules after treatment: 300 μm)

Porous cellulose particles 1: “VISCOPEARL MINI” manufactured by Rengo Co., Ltd. (average particle diameter: 400 μm, ratio of long diameter/short diameter of particles: 1.11, porosity: 87%)

Porous cellulose particles 2: “VISCOPEARL-MINI” manufactured by Rengo Co., Ltd. (average particle diameter: 700 μm, ratio of long diameter/short diameter of particles: 1.09, porosity: 80%)

Cellulose fine powder: Cellulose powder obtained by pulverizing a pulp with ball mill and then sieving (average particle diameter: 300 μm, porosity: 34%)

Polymer gel 1: “NANOPRENE M20” manufactured by LANXESS, hydroxyl-containing polymer gel having Tg of −20° C., including SBR as a base

Polymer gel 2: “NANOPRENE BM750H” manufactured by LANXESS, hydroxyl-containing polymer gel having Tg of −75° C., including BR as a base

Hardness of each rubber composition obtained was measured. A studless tire for passenger cars was prepared using each rubber composition. The tire had a size of 185/65R14. Each rubber composition was applied to a tread of the tire, and vulcanization molding was conducted according to the conventional method. Thus, a tire was produced. On-ice braking performance and abrasion resistance of each tire obtained were evaluated (rim used: 14×5.5JJ). Measurement and evaluation methods are as follows. Evaluations of hardness and on-ice braking performance were conducted before aging and after aging, respectively. The aging was performed by heat-deteriorating the tire in an oven of 70° C. for 2 weeks.

Hardness: Hardness at ordinary temperature (23° C.) of a test piece (thickness: 12 mm or more) obtained by vulcanization at 150° C. for 30 min was measured with durometer type A according to JIS K6253.

On-ice braking performance: Four tires obtained above were mounted on a 4WD car of 2,000 cc displacement. ABS was operated from 40 km/hr running on an ice floe road (air temperature: −3±3° C.) and a braking distance was measured (average value of n=10). Inverse number of a braking distance was indicated by an index as the value before aging in Comparative Example 1 being 100. Braking distance is short as the index is increased, and large index indicates excellent braking performance on an ice-covered road surface.

Abrasion resistance (before aging): Four tires obtained above were mounted on a 4WD car of 2,000 cc displacement, and the car was run over a distance of 10,000 km while making rotation between the tires on the right side and the tires of left side every 2,500 km on a general dry road surface. An average value of tread depths of four tires after running was indicated by an index as Comparative Example 1 being 100. Abrasion resistance is good as the numerical value is large.

The results obtained are shown in Table 1. In Comparative Example 1, excellent on-ice braking performance was obtained by adding the porous cellulose particles, but the increase of hardness after aging is large, and on-ice braking performance was greatly deteriorated by aging. On the other hand, in Examples 1 to 5 in which the polymer gel was added together with the porous cellulose particles, the increase of hardness after aging is suppressed, and excellent on-ice braking performance due to the addition of porous cellulose particles was substantially maintained without great decrease even after aging. In Comparative Example 2, the amount of the polymer gel added was too large, and abrasion resistance was greatly deteriorated. In Comparative Example 3, the amount of the porous cellulose particles added was too large, and hardness was large. Additionally, abrasion resistance was poor. In Comparative Example 4, the porous cellulose particles were not added, in Comparative Example 5, a cellulose powder that is not porous was used, and therefore, on-ice braking performance was poor before and after aging.

TABLE 1

| | | Com. | | | | | | Com. | Com. | Com. | Com. |
|---|---|---|---|---|---|---|---|---|---|---|---|
| | | Ex. 1 | Ex. 1 | Ex. 2 | Ex. 3 | Ex. 4 | Ex. 5 | Ex. 2 | Ex. 3 | Ex. 4 | Ex. 5 |
| Formulation (parts by mass) | | | | | | | | | | | |
| NR | | 50 | 50 | 50 | 50 | 50 | 50 | 50 | 50 | 50 | 50 |
| BR | | 50 | 50 | 50 | 50 | 50 | 50 | 50 | 50 | 50 | 50 |
| Carbon black | | 25 | 25 | 25 | 25 | 25 | 25 | 25 | 25 | 25 | 25 |
| Silica | | 25 | 25 | 25 | 25 | 25 | 25 | 25 | 25 | 25 | 25 |
| Silane coupling agent | | 2 | 2 | 2 | 2 | 2 | 2 | 2 | 2 | 2 | 2 |
| Paraffin oil | | 20 | 20 | 20 | 20 | 20 | 20 | 20 | 20 | 20 | 20 |
| Stearic acid | | 2 | 2 | 2 | 2 | 2 | 2 | 2 | 2 | 2 | 2 |
| Zinc flower | | 2 | 2 | 2 | 2 | 2 | 2 | 2 | 2 | 2 | 2 |
| Age resister | | 2 | 2 | 2 | 2 | 2 | 2 | 2 | 2 | 2 | 2 |
| Wax | | 2 | 2 | 2 | 2 | 2 | 2 | 2 | 2 | 2 | 2 |
| Vegetable granules | | 2 | 2 | 2 | 2 | 2 | 2 | 2 | 2 | 2 | 2 |
| Porous cellulose particles 1 | | 5 | 5 | 5 | 5 | 10 | | 5 | 30 | | |
| Porous cellulose particles 2 | | | | | | | 5 | | | | |
| Cellulose powder | | | | | | | | | | | 5 |
| Polymer gel 1 | | | 10 | | 20 | 10 | 10 | 40 | 10 | 10 | 10 |
| Polymer gel 2 | | | | 10 | | | | | | | |
| Vulcanization accelerator | | 1.5 | 1.5 | 1.5 | 1.5 | 1.5 | 1.5 | 1.5 | 1.5 | 1.5 | 1.5 |
| Sulfur | | 2 | 2 | 2 | 2 | 2 | 2 | 2 | 2 | 2 | 2 |
| Evaluation | | | | | | | | | | | |
| Hardness | Before aging | 50 | 51 | 50 | 52 | 52 | 52 | 53 | 61 | 50 | 51 |
| | After aging | 62 | 55 | 55 | 57 | 57 | 57 | 57 | 66 | 54 | 56 |
| | (After aging- | 12 | 4 | 5 | 5 | 5 | 5 | 4 | 5 | 4 | 5 |
| | before aging) | | | | | | | | | | |
| On-ice braking | Before aging | 100 | 100 | 102 | 100 | 105 | 107 | 98 | 103 | 92 | 94 |
| performance (Index) | After aging | 85 | 95 | 98 | 96 | 99 | 99 | 93 | 98 | 88 | 89 |

| | | | | | | | | | | |
|---|---|---|---|---|---|---|---|---|---|---|
| Abrasion resistance performance (Index) | 100 | 100 | 98 | 98 | 95 | 95 | 85 | 78 | 102 | 100 |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A rubber composition for a tire comprising:
100 parts by mass of a rubber component comprising a diene rubber;
from 0.3 to 20 parts by mass of porous cellulose particles having a porosity of from 75 to 95%; and
from 1 to 30 parts by mass of a polymer gel that is crosslinked diene polymer particles having a functional group containing a hetero atom.

2. The rubber composition for a tire according to claim 1, wherein the functional group of the polymer gel is at least one selected from the group consisting of a hydroxyl group, an amino group, a carboxyl group, an alkoxyl group and an epoxy group.

3. The rubber composition for a tire according to claim 1, wherein the polymer gel has a glass transition temperature of 0° C. or lower.

4. The rubber composition for a tire according to claim 1, further comprising vegetable granules and/or a pulverized product of a porous carbonized material of a plant in an amount of from 0.5 to 20 parts by mass per 100 parts by mass of the rubber component.

5. A pneumatic tire having a tread comprising the rubber composition according to claim 1.
